(19) United States
(12) Patent Application Publication
(10) Pub. No.: US 2012/0044142 A1
(43) Pub. Date: Feb. 23, 2012

(54) DISPLAY HAVING AUTO-OFF FUNCTION BY PERSON INFRARED SENSING

(75) Inventor: SHU-HONG WU, FUQING CITY (CN)

(73) Assignee: TPV ELECTRONICS (FUJIAN) CO., LTD., Fuqing City (CN)

(21) Appl. No.: 13/013,071

(22) Filed: Jan. 25, 2011

(30) Foreign Application Priority Data
Aug. 19, 2010 (TW) 099215977

(51) Int. Cl. G06F 3/033; G09G 3/36

(52) U.S. Cl. 345/158; 345/87

(57) ABSTRACT

A display having an auto-off function by person infrared sensing includes a display unit, an infrared sensor module, a control unit and a power supply unit. The infrared sensor module senses whether or not a person is within a zone surrounding the display, and generates a sensing trigger signal when sensing no person within the zone. A processor of the control unit stops outputting a control signal when keeping on receiving the sensing trigger signal for a predetermined period of time. The power supply unit supplies power to the control unit or to the display unit and the control unit when receiving the control signal, and enters a DC off mode to stop supplying power when not receiving the control signal. The present invention can automatically turn off the display when sensing no person within the zone for the predetermined period of time so as to achieve power saving.

### BACKGROUND OF THE INVENTION

1. Field of the Invention

The present invention relates to a display. More particularly, the present invention relates to a display having an auto-off function by person infrared sensing.

2. Description of the Related Art

Presently, a computer usually has a power management system for providing a power saving control function. For instance, when the computer host senses no operation input from a mouse or keyboard for a predetermined period of time, the host turns off the computer display and then the display enters a standby mode. Only when the host senses some operation input from the mouse or keyboard, the host turns on the display again and then the display returns to a normal mode. In the standby mode, the display turns off most function modules to save significant power consumption and maintains few function modules to offer, for example, remote control and digital clock functions to avoid having to wait for the display to reboot or reset. In the normal mode, the display turns on all or most function modules.

However, when a person uses the computer to work, if the person reads paper documents and hence no operation is input to the computer for the predetermined period of time, the host will also turn off the display and then the display enters the standby mode. If the person changes his/her sight to the display, the person will have to stop working and do some operation input through the mouse or keyboard to awake the display so as to interrupt the person's work. Accordingly, the person usually tends to turn off the power saving control function to avoid frequent interrupts. After turning off the power saving control function, the person usually forgets to turn on the power saving control function again or turn off the display before leaving the computer. It results in a waste of power and fails to achieve power saving.

### SUMMARY OF THE INVENTION

Accordingly, a display is provided for being automatically turned to control the display to enter a direct-current (DC) off mode when sensing a person leaving the display for a predetermined period of time. In the DC off mode, the display turns off its internal DC power supply to turn off all function modules to save the most power consumption.

According to an aspect of the present invention, a display having an auto-off function by person infrared sensing includes a display unit, an infrared sensor module, a control unit and a power supply unit. The display unit displays images. The infrared sensor module senses whether or not a person is within a zone surrounding the display, and generates a sensing trigger signal when sensing no person within the zone. The control unit is coupled to the display unit and the infrared sensor module. The control unit includes a processor, and the processor stops outputting a control signal when keeping on receiving the sensing trigger signal for a predetermined period of time. The power supply unit is coupled to the display unit and the control unit. The power supply unit supplies power to the control unit or to the display unit and the control unit when receiving the control signal, and enters a DC off mode to stop supplying power when not receiving the control signal.

The present invention applies the person infrared sensing technology to the display so that the display is automatically turned off to enter the DC off mode when sensing no person within the zone surrounding the display (that is, the person leaving the display) for the predetermined period of time so as to achieve power saving and avoid the above-mentioned frequent interrupts. In addition, when the display enters the DC off mode, the person must manually turn on the display by, for example, pressing a power button disposed on the display or a remote controller.

### BRIEF DESCRIPTION OF THE DRAWINGS

The foregoing and other features of the disclosure will be apparent and easily understood from a further reading of the specification, claims and by reference to the accompanying drawings in which:

FIG. 1 is a schematic block diagram illustrating an embodiment of a display having an auto-off function by person infrared sensing according to the present invention;

FIG. 2 is a schematic diagram illustrating an embodiment of the infrared sensor module shown in FIG. 1;

FIG. 3 is a flowchart illustrating an embodiment of a method for automatically turning off a display by person infrared sensing according to the present invention;

FIG. 4 is a flowchart illustrating another embodiment of a method for automatically turning off a display by person infrared sensing according to the present invention; and

FIG. 5 is a schematic block diagram illustrating another embodiment of a display having an auto-off function by person infrared sensing according to the present invention.

### DESCRIPTION OF THE PREFERRED EMBODIMENTS

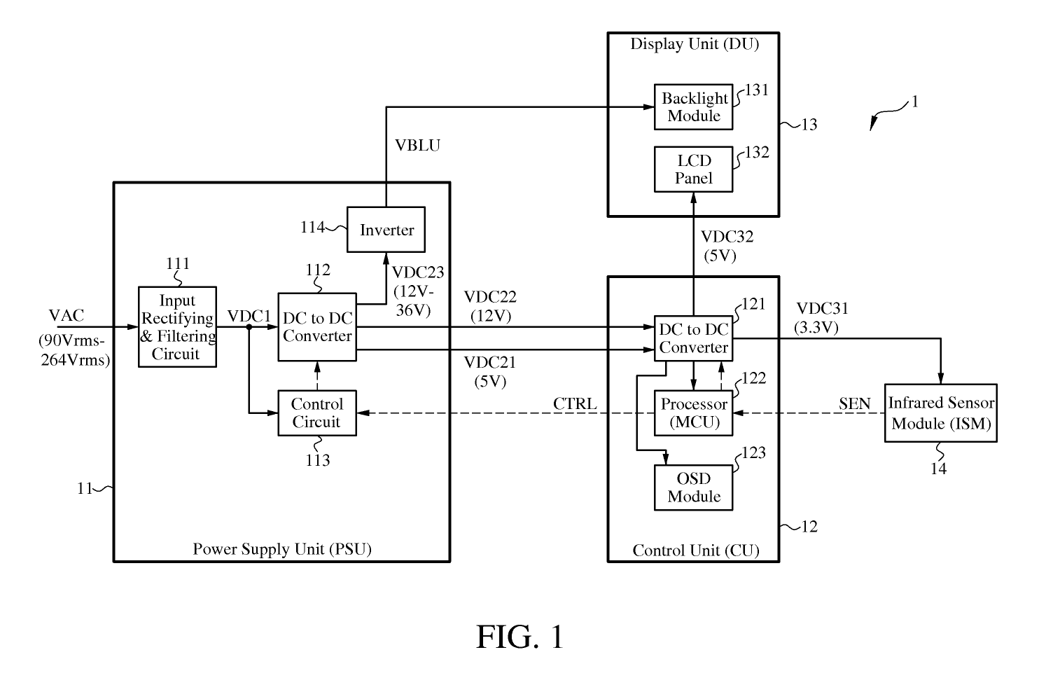

FIG. 1 is a schematic block diagram illustrating an embodiment of a display having an auto-off function by person infrared sensing according to the present invention, in which solid lines with arrows are power lines, and dashed lines with arrows are signal lines. Referring to FIG. 1, a display 1 having an auto-off function by person infrared sensing is, for example, a liquid crystal display (LCD) television, an LCD monitor or an all-in-one computer. The display 1 includes a power supply unit (PSU) 11, a control unit (CU) 12, a display unit (DU) 13 and an infrared sensor module (ISM) 14. The power supply unit 11 includes an input rectifying and filtering circuit 111, a DC to DC converter 112, a control circuit 113 and an inverter 114. The control unit 12 includes a DC to DC converter 121, a processor 122 and an on-screen display (OSD) module 123. The display unit 13 includes a backlight module 131 and a LCD panel 132.

In the power supply unit 11, the input rectifying and filtering circuit 111 includes, for example, an electromagnetic interference filter, a bridge rectifier and an electrolytic capacitor of large capacitance. The input rectifying and filtering circuit 111 receives an alternating-current (AC) supply voltage VAC input (such as 90 Vrms-264 Vrms) and converts the AC supply voltage VAC into a first DC supply voltage VDC1. The DC to DC converter 112 employs, for example, a full-bridge or half-bridge DC to DC converter.

The DC to DC converter 112 is coupled to the input rectifying and filtering circuit 111. The DC to DC converter 112 converts the first DC supply voltage VDC1 into a plurality of second DC supply voltages VDC21-VDC23. The second DC supply voltages VDC21 and VDC22 (such as 5V and 12V, respectively) supply power to the control unit 12. The second DC supply voltage VDC23 (such as 12V-36V) is further converted into a backlight supply voltage VBLU by the inverter 114 to supply power to the display unit 13.

The control circuit 113 is coupled to the input rectifying and filtering circuit 111 and supplied power from the first DC supply voltage VDC1. The control circuit 113 is further coupled to the DC to DC converter 112 and the processor 122. When the control circuit 113 receives a control signal CTRL outputted from the processor 122, the control circuit 113 controls, according to the control signal CTRL, the DC to DC converter 112 to cause the power supply unit 11 to enter a standby mode to supply power to the control unit 12 or to enter a normal mode to supply power to the control unit 12 and the display unit 13. When the control circuit 113 does not receive the control signal CTRL, the control circuit 113 does not control the DC to DC converter 112 anymore to cause the power supply unit 11 to enter a DC off mode to stop supplying power.

In the control unit 12, the DC to DC converter 121 converts the second DC supply voltages VDC21 and VDC22 provided from the power supply unit 11 into a plurality of DC supply voltages to supply power to the internal components of the control unit 12 such as the processor 122 and the OSD module 123. In this embodiment, the DC to DC converter 121 further converts to generate a plurality of third DC supply voltages VDC31 and VDC32 (such as 3.3V and 5V, respectively). The third DC supply voltage VDC31 supplies power to the infrared sensor module 14, and the third DC supply voltage VDC32 supplies power to the LCD panel 132.

The processor 122 is, for example, a micro control unit (MCU). When the power supply unit 11 enters the normal mode, the processor 122 controls the DC to DC converter 121 and controls the DC to DC converter 112 through the control circuit 113 to supply power to the control unit 12 and the display unit 13. When the processor 122 keeps on receiving a sensing trigger signal SEN for a predetermined period of time, the processor 122 stops outputting the control signal CTRL and then the power supply unit 11 enters the DC off mode to stop supplying power.

Because the infrared sensor module 14 senses whether or not a person is within a zone surrounding the display 1 and generates the sensing trigger signal SEN when sensing no person within the zone, once the processor 122 receives the sensing trigger signal SEN, the processor 122 can determine that no person is within the zone and start to count time until it does not receive the sensing trigger signal SEN anymore. When the processor 122 keeps on receiving the sensing trigger signal SEN for the predetermined period of time, the processor 122 can determine that no person is within the zone for the predetermined period of time. Accordingly, the processor 122 stores the display settings such as brightness and contrast settings, and then controls the DC to DC converter 121 to stop supplying power to the LCD panel 132 and outputs the control signal CTRL to the control circuit 113 to control the DC to DC converter 112 to turn off the backlight module 131, and finally stops outputting the control signal CTRL. When the control circuit 113 does not receive the control signal CTRL, the control circuit 113 does not control the DC to DC converter 112 anymore to cause the power supply unit 11 to enter the DC off mode to stop supplying power.

In one embodiment, when the processor 122 does not keep on receiving the sensing trigger signal SEN for the predetermined period of time and no image is input for a preset period of time, the processor 122 controls the DC to DC converter 121 to stop supplying power to the LCD panel 132, and outputs the control signal CTRL to the control circuit 113 to control the DC to DC converter 112 to cause the power supply unit 11 to enter the standby mode. Accordingly, the inverter 114 cannot obtain sufficient power from the DC to DC converter 112 so as to enter a protection state to stop providing the backlight supply voltage VBLU. Therefore, the display unit 13 are turned off in whole.

The OSD module 123 provides a user interface for the person to set the predetermined period of time and/or whether or not the auto-off function is activated. If the person sets that the auto-off function is not activated, the processor 122 will ignore the sensing trigger signal SEN when receiving the sensing trigger signal SEN.

In the display unit 13, the backlight module 131 provides light for the LCD panel 132 to display images. In this embodiment, the backlight module 131 employs, but not limited to, cold cathode fluorescent lamps (CCFLs) as a backlight source of the backlight module 131, and accordingly the inverter 114 is required to convert the second DC supply voltage VDC23 into the high-voltage AC backlight supply voltage VBLU to supply power to the backlight module 131. In an alternative embodiment, the backlight module 131 can employ light-emitting diodes (LEDs) as the backlight source, and accordingly a DC to DC converter is required to replace the inverter 114 to convert the second DC supply voltage VDC23 into a low-voltage DC backlight supply voltage VBLU to supply power to the backlight module.

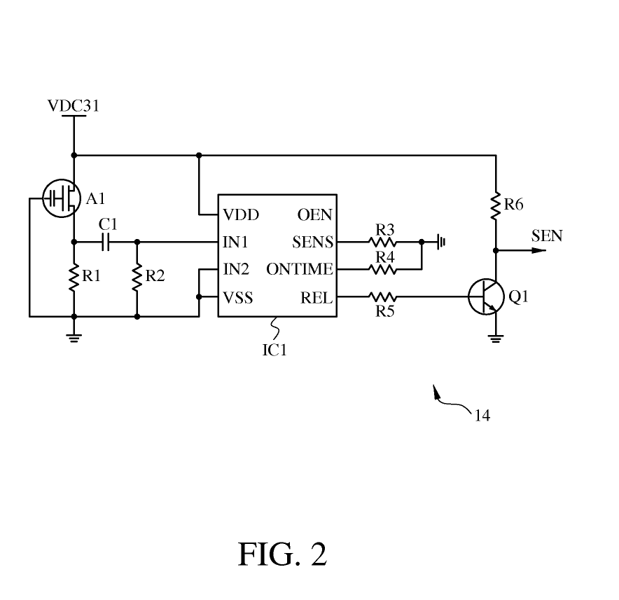

FIG. 2 is a schematic diagram illustrating an embodiment of the infrared sensor module 14 shown in FIG. 1. Referring to FIG. 2, the infrared sensor module 14 includes a passive infrared sensor (PIR) A1, an amplifying and filtering circuit IC1 and a transistor Q1. The passive infrared sensor A1 senses person's infrared radiation to determine whether or not a person is within the zone. The amplifying and filtering circuit IC1 is, for example, an integrated circuit PS204 having a positive supply terminal VDD, a supply ground terminal VSS, a sensor input 1 terminal IN1, a sensor input 2 terminal IN2, a day/night mode select terminal OEN, a sensitivity terminal SENS, a timer terminal ONTIME and a relay out terminal REL.

The positive supply terminal VDD and the supply ground terminal VSS are coupled to the third DC supply voltage VDC31 and ground, respectively, so that the third DC supply voltage VDC31 supplies power to the amplifying and filtering circuit IC1. When a person is within the zone, the passive infrared sensor A1 generates a sensing current, and then the sensing current flows through a resistor R1 to be converted into a corresponding sensing voltage. The sensing voltage is filtered by a resistor R2 and a capacitor C1 and input to the sensor input 1 terminal IN1 and the sensor input 2 terminal IN2. The amplifying and filtering circuit IC1 employs a differential input stage to amplify the filtered sensing voltage and outputs a high-level signal from the relay out terminal REL to turn on the transistor Q1 through resistors R5 and R6 so that the voltage level of the sensing trigger signal SEN is low and represents to output the sensing trigger signal SEN. When no person is within the zone, the amplifying and filtering circuit IC1 outputs a low-level signal from the relay out terminal REL to turn off the transistor Q1 through resistors R5 and R6 so that the voltage level of the sensing trigger signal SEN is high and represents not to output the sensing trigger signal SEN. The threshold voltage of determining the sensing voltage can be set by selecting a resistance of a resistor R3, and a period of time of the relay out terminal REL output staying active can be set by selecting a resistance of a resistor R4.

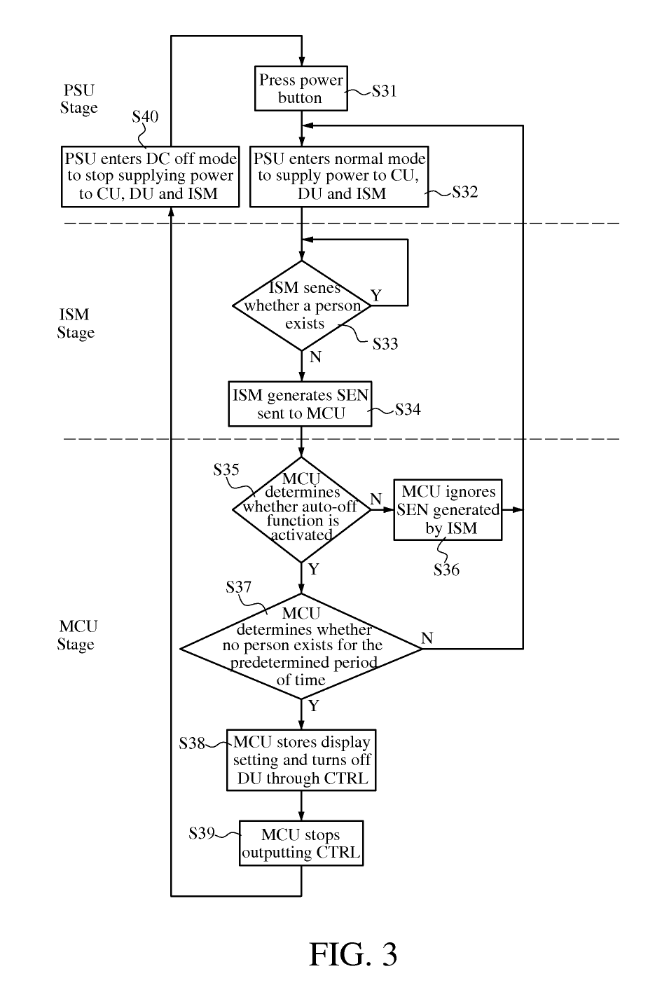

FIG. 3 is a flowchart illustrating an embodiment of a method for automatically turning off a display by person infrared sensing according to the present invention, in which the method is adapted for the display 1 shown in FIG. 1. Referring to FIGS. 1 and 3, a method for automatically turning off the display 1 by person infrared sensing includes three stages related to the power supply unit 11, the infrared sensor module 14 and the processor 122. A person turns on the power supply unit 11 to enter the normal mode by, for example, manually pressing a power button disposed on the display 1 or a remote controller (Step S31). In the normal mode, the power supply unit 11 supplies power to the control unit 12, the display unit 13 and the infrared sensor module 14, in which the infrared sensor module 14 is indirectly supplied power from the power supply unit 11 through the display unit 13 as shown in FIG. 1 (Step S32).

The infrared sensor module 14 starts to work and senses whether or not a person is within the zone surrounding the display 1 (Step S33). Because the person who presses the power button is sure to exist within the zone surrounding the display 1, the infrared sensor module 14 will sense that there is a person within the zone until the person's first time to leave the zone. When the infrared sensor module 14 senses no person within the zone, the infrared sensor module 14 generates the sensing trigger signal SEN sent to the processor 122 (Step S34).

The processor 122 determines whether or not the auto-off function is activated (Step S35). When the recent display setting indicates that the person uses the user interface provided by the OSD module 123 to set that the auto-off function is not activated, the processor 122 will ignore the sensing trigger signal SEN generated by the infrared sensor module 14 (Step S36) and then the process returns to Step S32 to go on. When the recent display setting indicates that the person sets that the auto-off function is activated, the processor 122 determines whether or not it keeps on receiving the sensing trigger signal SEN (i.e. sensing no person within the zone) for the predetermined period of time (Step S37).

When the processor 122 determines that it does not keep on receiving the sensing trigger signal SEN for the predetermined period of time, it represents that no person is within the zone and the period of time of no person within the zone does not exceed the predetermined period of time yet so that the process returns to Step S32 to go on. When the processor 122 determines that it keeps on receiving the sensing trigger signal SEN for the predetermined period of time, it represents that no person is within the zone and the period of time of no person within the zone exceeds the predetermined period of time so that the processor 122 stores the display settings and then controls the DC to DC converter 121 to stop supplying power to the LCD panel 132 and outputs the control signal CTRL to the control circuit 113 to control the DC to DC converter 112 to turn off the backlight module 131 (Step S38), and finally stops outputting the control signal CTRL (Step S39). When the control circuit 113 does not receive the control signal CTRL, the control circuit 113 does not control the DC to DC converter 112 anymore to cause the power supply unit 11 to enter the DC off mode to stop supplying power to the control unit 12, the display unit 13 and the infrared sensor module 14 (Step S40), and accordingly the person must press the power button (Step S31) if the person wants to turn on the display 1 again.

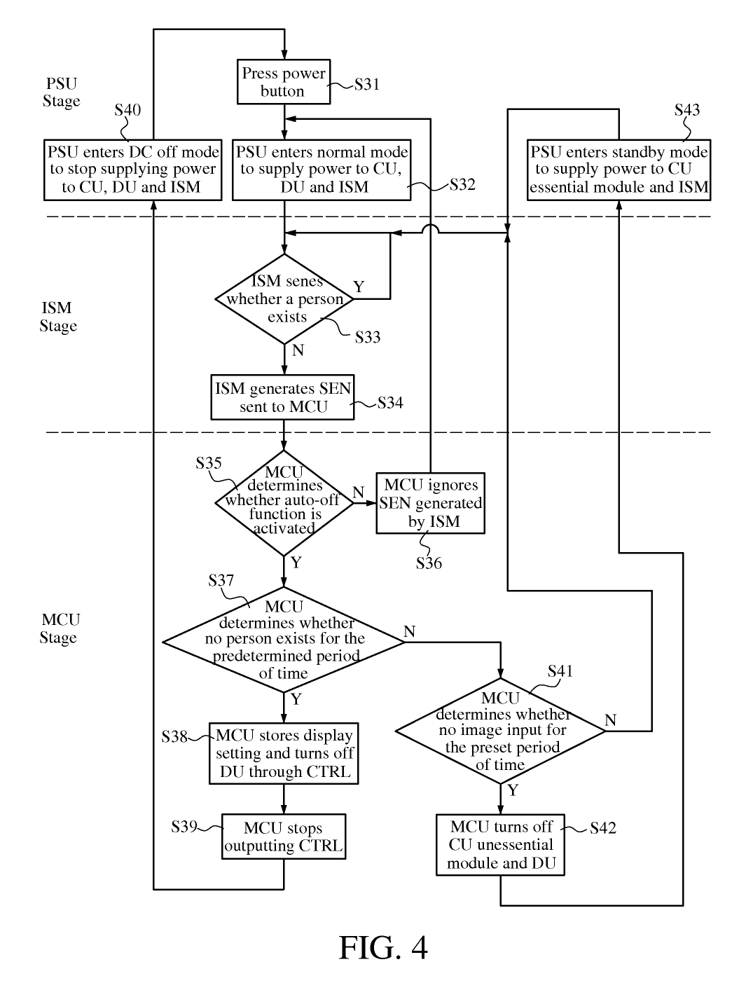

FIG. 4 is a flowchart illustrating another embodiment of a method for automatically turning off a display by person infrared sensing according to the present invention, in which the method is adapted for the display 1 shown in FIG. 1. Referring to FIGS. 3 and 4, a method shown in FIG. 4 and the method shown in FIG. 3 differs in “N” path at Step S37. Referring to FIGS. 1 and 4, when the processor 122 determines that it does not keep on receiving the sensing trigger signal SEN for the predetermined period of time, it represents that the period of time of no person within the zone does not exceed the predetermined period of time yet so that the processor 122 further determines whether or not no image is input for the preset period of time (Step S41).

When the processor 122 determines that no image is input and the period of time of no image input does not exceeds the preset period of time, the process returns to Step S33 to go on. When the processor 122 determines that no image is input for the preset period of time, it represents that although the period of time of no person does not exceed the predetermined period of time, but the period of time of no image input exceeds the preset period of time so that the display 1 is almost in idle. Accordingly, the processor 122 turns off the input/output of unessential modules of the control unit 12 (such as the OSD module 123), controls the DC to DC converter 121 to stop supplying power to the LCD panel 132 and outputs the control signal CTRL to the control circuit 113 to control the DC to DC converter 112 to cause the power supply unit 11 to enter the standby mode. The inverter 114 cannot obtain sufficient power from the DC to DC converter 112 so as to enter a protection state to stop providing the backlight supply voltage VBLU so that the display unit 13 is turned off in whole (Step S42). Then, the power supply unit 11 enters the standby mode to only supply power to essential modules of the control unit 12 (such as the processor 122) and the infrared sensor module 14 (Step S43), and the process returns to Step S33 to go on.

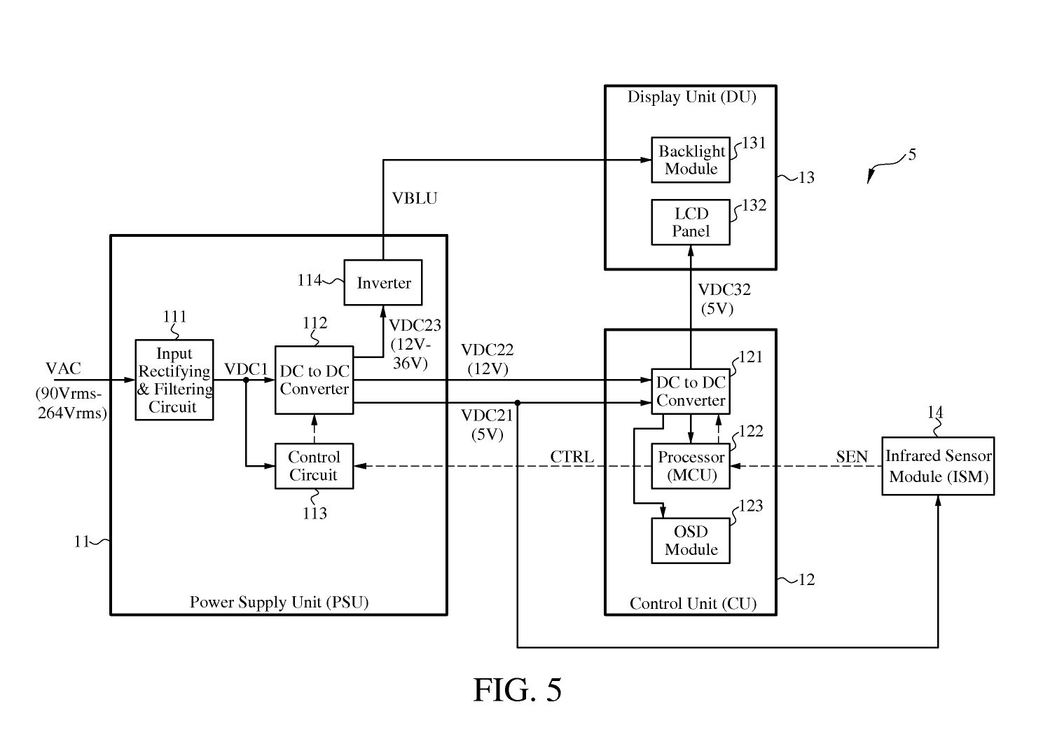

FIG. 5 is a schematic block diagram illustrating another embodiment of a display having an auto-off function by person infrared sensing according to the present invention. Referring to FIGS. 1 and 5, a display 5 shown in FIG. 5 and the display 1 shown in FIG. 1 differ in how to supply power to the infrared sensor module 14. In the display 1, the DC to DC converter 121 converts the second DC supply voltage VDC21 or VDC22 into the third DC supply voltage VDC31 to supply power to the infrared sensor module 14. In the display 5, the infrared sensor module 14 is further coupled to the power supply unit 11 and supplied power from the second DC supply voltage VDC21. Therefore, the infrared sensor module 14 of the display 1 is directly supplied power from the control unit 12 or indirectly supplied power from the power supply unit 11 through the control unit 12, and the infrared sensor module 14 of the display 5 is directly supplied power from the power supply unit 11.

In summary, the present invention applies the person infrared sensing technology to the display so that the display is automatically turned off to enter the DC off mode when sensing no person within the zone surrounding the display (that is, the person leaving the display) for the predetermined period of time so as to achieve power saving and avoid the above-mentioned frequent interrupts. In addition, when the display enters the DC off mode, the person must manually turn on the display by, for example, pressing a power button disposed on the display or a remote controller.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

I claim:

1. A display having an auto-off function by person infrared sensing, comprising:
a display unit for displaying images;
an infrared sensor module for sensing whether or not a person is within a zone surrounding the display, and generating a sensing trigger signal when sensing no person within the zone;
a control unit coupled to the display unit and the infrared sensor module, the control unit comprising a processor, the processor for stopping outputting a control signal when keeping on receiving the sensing trigger signal for a predetermined period of time; and
a power supply unit coupled to the display unit and the control unit, the power supply unit for supplying power to the control unit or to the display unit and the control unit when receiving the control signal, and entering a direct-current (DC) off mode to stop supplying power when not receiving the control signal.

2. The display having an auto-off function by person infrared sensing according to claim 1, wherein the infrared sensor module is supplied power from the control unit.

3. The display having an auto-off function by person infrared sensing according to claim 1, wherein the infrared sensor module is further coupled to the power supply unit, and the infrared sensor module is supplied power from the power supply unit.

4. The display having an auto-off function by person infrared sensing according to claim 1, wherein the infrared sensor module comprises a passive infrared sensor, the passive infrared sensor for sensing person's infrared radiation to determine whether or not a person is within the zone.

5. The display having an auto-off function by person infrared sensing according to claim 1, wherein the control unit further comprises an on-screen display (OSD) module, the OSD module for providing a user interface to set the predetermined period of time or whether or not the auto-off function is activated, wherein if the auto-off function is not activated, the processor will ignore the sensing trigger signal when receiving the sensing trigger signal.

6. The display having an auto-off function by person infrared sensing according to claim 1, wherein the processor for outputting the control signal to control the power supply unit to enter a standby mode when not keeping on receiving the sensing trigger signal for the predetermined period of time and no image input for a preset period of time.

7. The display having an auto-off function by person infrared sensing according to claim 1, wherein the power supply unit comprises:
an input rectifying and filtering circuit for receiving an alternating-current (AC) supply voltage and converting the AC supply voltage into a first DC supply voltage;
a DC to DC converter coupled to the input rectifying and filtering circuit, the DC to DC converter for converting the first DC supply voltage into a plurality of second DC supply voltages to supply power to the display unit and the control unit; and
a control circuit coupled to the DC to DC converter and the processor, the control circuit for controlling the DC to DC converter to supply power to the control unit or to the display unit and the control unit when receiving the control signal, and not controlling the DC to DC converter so that the power supply unit enters the DC off mode to stop supplying power when not receiving the control signal.

8. The display having an auto-off function by person infrared sensing according to claim 1, wherein the display comprises a liquid crystal display (LCD).

9. The display having an auto-off function by person infrared sensing according to claim 8, wherein the LCD comprises an LCD television or an LCD monitor.

10. The display having an auto-off function by person infrared sensing according to claim 8, wherein the LCD comprises an all-in-one computer.
